(19) United States
(12) Patent Application Publication
(10) Pub. No.: US 2025/0301359 A1
(43) Pub. Date: Sep. 25, 2025

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Xuan MA, Shenzhen (CN); Mengzhu CHEN, Shenzhen (CN); Bo DAI, Shenzhen (CN); Xiaoying MA, Shenzhen (CN); Jun XU, Shenzhen (CN)

(73) Assignee: ZTE CORPORATION, Shenzhen (CN)

(21) Appl. No.: 19/222,070

(22) Filed: May 29, 2025

Related U.S. Application Data
(63) Continuation of application No. PCT/CN2023/076914, filed on Feb. 17, 2023.

(51) Int. Cl. H04W 24/10; H04B 7/06; H04W 72/23; H04W 76/28

(52) U.S. Cl. CPC H04W 24/10; H04B 7/0626; H04W 72/23; H04W 76/28

(57) ABSTRACT

A wireless communication method is disclosed. The wireless communication method includes: receiving, by a wireless communication terminal from a wireless communication node, at least one of a first signaling, a second signaling, or a third signaling; and performing, by the wireless communication terminal, at least one of a measurement or a reporting according to the received at least one of a first signaling, a second signaling, or a third signaling.

### CROSS-REFERENCE TO RELATED PATENT APPLICATIONS

This application is a Continuation of PCT Application No. PCT/CN2023/076914, filed Feb. 17, 2023, incorporated herein by reference in its entirety.

### TECHNICAL FIELD

This document is directed generally to wireless communications, and in particular to 5th generation (5G) wireless communications.

### BACKGROUND

Generally, a gNB (gNode B) uses a fixed transmission power (e.g., PSD, power spectral density) for the DL (downlink) transmission, which may not be beneficial to the NW (new radio) power consumption. To reduce the network energy power consumption, the dynamic power adjustment can be introduced. When the dynamic power adjustment is adopted, the semi-static parameter, e.g., the power offset between the PDSCH (physical downlink shared channel) and the CSI-RS (channel status information reference signals) may result in an inaccurate CSI report or feedback.

### SUMMARY

This document relates to methods, systems, and computer program products for a measurement or reporting.

One aspect of the present disclosure relates to a wireless communication method. In an embodiment, the wireless communication method includes: receiving, by a wireless communication terminal from a wireless communication node, at least one of a first signaling, a second signaling, or a third signaling; and performing, by the wireless communication terminal, at least one of a measurement or a reporting according to the received at least one of a first signaling, a second signaling, or a third signaling.

Another aspect of the present disclosure relates to a wireless communication method. In an embodiment, the wireless communication method includes: transmitting, by a wireless communication node to a wireless communication terminal, at least one of a first signaling, a second signaling, or a third signaling to allow the wireless communication terminal to perform at least one of a measurement or a reporting according to the received at least one of a first signaling, a second signaling, or a third signaling, and receiving, by the wireless communication node from the wireless communication terminal, a reporting based on at least one of the first signaling, the second signaling, or the third signaling.

Another aspect of the present disclosure relates to a wireless communication terminal. In an embodiment, the wireless communication terminal includes a communication unit and a processor. The processor is configured to: receive, from a wireless communication node, at least one of a first signaling, a second signaling, or a third signaling; and perform at least one of a measurement or a reporting according to the received at least one of a first signaling, a second signaling, or a third signaling.

Another aspect of the present disclosure relates to a wireless communication node. In an embodiment, the wireless communication node includes a communication unit and a processor. The processor is configured to: transmit, to a wireless communication terminal, at least one of a first signaling, a second signaling, or a third signaling to allow the wireless communication terminal to perform at least one of a measurement or a reporting according to the received at least one of the first signaling, the second signaling, or the third signaling.

Various embodiments may preferably implement the following features:

Preferably or in some embodiments, the measurement comprises at least one of a channel state information, CSI, measurement, or a beam measurement; and the reporting comprises at least one of a CSI reporting or beam reporting.

Preferably or in some embodiments, the first signaling comprises Radio Resource Control, RRC, signaling, and the RRC signaling comprises at least one of: one or more CSI resource configurations for one or more CSI resources, one or more CSI report configurations, a first power offset set, a second power offset set, a third power offset set, a port set, or a Transmission Configuration Indicator, TCI, state set.

Preferably or in some embodiments, the CSI resources comprises at least one of: one or more channel state information reference signal, CSI-RS, resources, one or more CSI-RS resource sets, or one or more CSI-RS resource settings.

Preferably or in some embodiments, the first power offset set comprises one or more candidate power control offsets, wherein the candidate power control offset is the assumed ratio of a physical downlink shared channel, PDSCH, Energy Per Resource Element, EPRE, to a non-zero-power, NZP, CSI-RS EPRE.

Preferably or in some embodiments, the second power offset set comprises one or more candidate power control offsets, wherein the candidate power control offset is the assumed ratio of an NZP CSI-RS EPRE to a synchronization signal physical broadcast channel, SS/PBCH, block EPRE.

Preferably or in some embodiments, the third power offset set comprises one or more candidate power control offsets, wherein the candidate power control offset is a compensating power offset for compensating for an assumed ratio of a PDSCH EPRE, to an NZP CSI-RS EPRE, or an assumed ratio of an NZP CSI-RS EPRE to a SS/PBCH block EPRE.

Preferably or in some embodiments, at least one of the first power offset set, the second power offset set, or the third power offset set are configured in at least one of: an NZP-CSI-RS-Resource information element, an NZP-CSI-RS-ResourceSet information element, or a CSI-ResourceConfig information element.

Preferably or in some embodiments, the TCI state set comprises one or multiple TCI states, and, each TCI state provides at least one of Quasi co-location, QCL, source, QCL type, or spatial information.

Preferably or in some embodiments, the second signaling comprises a Medium Access Control Control Element, MAC CE, and the MAC CE indicates at least one of: an activation or deactivation of one or more candidate power control offsets within at least one of the first power offset set, the second power offset set, or the third power offset set, an activation or deactivation of one or more CSI resources, or an activation or deactivation of one or more TCI states within a TCI state set.

Preferably or in some embodiments, the MAC CE comprises at least one of:
a first field to indicate an identity of a serving cell for which the MAC CE applies;
a second field to indicate a bandwidth part, BWP, identifier for which the MAC CE applies;
a third field to indicate the activation or deactivation of candidate power control offsets in the first power offset set;
a fourth field to indicate the activation or deactivation of candidate power control offsets in the second power offset set;
a fifth field to indicate the activation or deactivation of candidate power control offsets in the third power offset set;
a sixth field to identify one or more CSI resources configuration, and the CSI resource configuration comprising at least one of:
one or more CSI-RS resource identifier;
one or more CSI-RS resource set identifier;
one or more CSI-ResourceConfig identifier;
a seventh field to indicate the updated CSI resources; or
an eighth field to indicate the activation or deactivation of the TCI states in the TCI state set.

Preferably or in some embodiments, the MAC CE is used for at least one of: a periodic CSI-RS, a periodic sounding reference signal, SRS, or a positioning reference signal, PRS.

Preferably or in some embodiments, an indication of the MAC CE is effective under at least one of the following conditions:
the indication is effective after a certain duration from receiving the MAC CE;
the indication is effective from a next CSI-RS measurement occasion after receiving the MAC CE; or
the indication is effective until a CSI report is triggered.

Preferably or in some embodiments, the indication of the MAC CE being effective comprises at least one of: a CSI measurement being performed by the wireless communication terminal using one or more indicated power offsets, a CSI measurement being performed by the wireless communication terminal using an updated CSI resource, or a CSI measurement being performed by the wireless communication terminal using an updated TCI state.

Preferably or in some embodiments, the wireless communication terminal derives CSI feedback according to at least one of one or more indicated power offsets or one or more updated CSI resources under at least one of the following conditions:
an indication of the MAC CE is effective;
the wireless communication terminal derives the CSI feedback from a next CSI reporting occasion; or
the wireless communication terminal derives the CSI feedback after receiving Downlink Control Information, DCI, triggering a CSI reporting.

Preferably or in some embodiments, the third signaling comprises DCI, and the DCI is at least one of: a DCI format 0_1, a DCI format 0_2 with a cyclic redundancy check, CRC, scrambled by a Cell Radio Network Temporary Identifier, C-RNTI, a Configured Scheduling Radio Network Temporary Identifier, CS-RNTI, a Modulation and Coding Scheme Cell Radio Network Temporary Identifier, MCS-C-RNTI, a Semi-Persistent CSI RNTI, SP-CSI-RNTI, or a network energy saving RNTI, NES-RNTI, a DCI format 2-6, a DCI format 2-7, a DCI format 2-1, a DCI format 2-2, or a group common DCI.

Preferably or in some embodiments, the DCI comprises one or more fields comprising at least one of:
a first field comprising at least one of a flag indicating whether the one or more fields in the DCI are reinterpreted or an indication indicating a type of a power offset to be used;
a second field to indicate selected power offsets;
a third field to indicate one or more updated CSI resources;
a fourth field to indicate a cell discontinuous transmission and/or discontinuous reception, DTX/DRX, or user equipment, UE, connected mode discontinuous reception, CDRX, configuration related information;
a fifth field to indicate a number of ports used for at least one of a CSI measurement or a CSI report;
a sixth field to indicate at least one of:
a BWP identifier;
one or more CSI-RS resource identifiers;
one or more CSI-RS resource set identifiers;
one or more CSI-ResourceConfig identifiers;
or, a seventh field to indicate the activation or deactivation of the TCI states in the TCI state set.

Preferably or in some embodiments, the second field is in a form of a codepoint, each codepoint is mapped to a target power offset or a target power offset group, and the target power offset is a configured power offset or a power offset activated by an MAC CE.

Preferably or in some embodiments, a length of the second field is determined by a higher layer parameter or set to a fixed number.

Preferably or in some embodiments, the third field is in a form of a codepoint, and each codepoint is associated with a CSI resource identifier or a CSI resource group identifier.

Preferably or in some embodiments, the DCI comprises more than one blocks, and each block comprises one or more fields and satisfies at least one of:
a starting position of one of the blocks is determined by a higher layer parameter; or
at least one of the blocks is associated with at least one of: a UE identifier, an index, a CSI resource identifier, or a BWP identifier.

Preferably or in some embodiments, an indication of the DCI is effective under at least one of the following conditions:
the indication is effective after a certain duration from receiving the DCI;
the indication is effective from a next CSI-RS measurement occasion after receiving the DCI; or
the indication is effective until a CSI report is triggered.

Preferably or in some embodiments, the indication of the DCI being effective comprises at least one of: a CSI measurement being performed by the wireless communication terminal using one or more indicated power offsets or a CSI measurement being performed by the wireless communication terminal using an updated CSI resource, or a CSI measurement being performed by the wireless communication terminal using an updated TCI state.

Preferably or in some embodiments, the wireless communication terminal derives CSI feedback according to an indication of the DCI under least one of the following conditions:
an indication of the DCI is effective;
the wireless communication terminal derives the CSI feedback from a next CSI reporting occasion; or
the wireless communication terminal derives the CSI feedback after receiving information triggering a CSI reporting.

Preferably, an indication of the first signaling is not applied on at least one of:
a CSI-RS for a tracking;
a CSI-RS for a layer 1 signal-to-noise and interference ratio, L1-SINR, computation;
a CSI-RS for a mobility; or
a CSI-RS for a layer 1 reference signal received power, L1-RSRP, computation.

Preferably or in some embodiments, at least one of the first signaling, the second signaling or the third signaling comprises at least one of: a threshold value associated with a radio link quality, a number of resources for a beam measurement, a timer value associated with a radio link measurement, or a counter value associated with the radio link measurement.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIGS. 1 to 6 show examples of signaling according to an embodiment of the present disclosure.

FIG. 7 shows an example of a schematic diagram of a wireless terminal according to an embodiment of the present disclosure.

FIG. 8 shows an example of a schematic diagram of a wireless network node according to an embodiment of the present disclosure.

FIGS. 9 to 10 show flowcharts of methods according to some embodiments of the present disclosure.

### DETAILED DESCRIPTION

A UE can be configured according to one or more CSI report configuration(s) by CSI-ReportConfig signaling. The CSI-ReportConfig may be associate with one or more CSI-RS resource setting(s) by CSI-resourceConfigID. The CSI-RS resource setting(s) is/are configured by CSI-ResourceConfig signaling.

The UE can be configured with one or more NZP CSI-RS resource set configuration(s) as indicated by the higher layer parameters CSI-ResourceConfig and NZP-CSI-RS-ResourceSet. Each NZP CSI-RS resource set may include more than one NZP CSI-RS resources.

The IE (information element) CSI-MeasConfig is used to configure the CSI-RS (reference signal) belonging to the serving cell in which CSI-MeasConfig is included.

In an embodiment, the UE (user equipment) receives a signaling (e.g., from a gNB) and performs corresponding operations. The signaling may comprise at least one of RRC (radio resource control) signaling, a MAC CE (medium access control control element) or downlink control information (DCI). The corresponding operations may include at least one of the measurement or the reporting.

In some embodiments, the measurement includes the CSI measurement, and the reporting includes the CSI reporting.

In some embodiments, the measurement includes the beam measurement, and/or the reporting includes the beam reporting.

In some embodiments, the RRC, MAC CE, or DCI signaling includes at least one of the following: a threshold value associated with the radio link quality, a number of resources for the beam measurement, a timer value associated with the radio link measurement, or a counter value associated with the radio link measurement.

In some embodiments, the radio link measurement includes CSI-RS measurement for L1-RSRP, or L1-SINR.

In some embodiments, the radio link measurement includes SSB measurement for L1-RSRP, or L1-SINR.

In some embodiments, the threshold value associated with the radio link quality includes at least one of a threshold value to assess whether radio link quality is in-sync, or a threshold value to assess whether radio link quality is out-of-sync.

In some embodiments, the timer includes timer T310, or timer T312. In some embodiments, the counter includes counter N310, or counter N312.

In some embodiments, the RRC, MAC CE, or DCI signaling includes at least one of the following: a scaling factor of the threshold value associated with the radio link quality, a number of resources for the beam measurement, a scaling factor of a timer value associated with the radio link measurement, or a scaling factor of a counter value associated with the radio link measurement.

In an embodiment, the gNB transmits a signaling (e.g., to the UE), wherein the signaling comprises at least one of a RRC signaling, a MAC CE or a downlink control information (DCI).

In an embodiment, the gNB receives the CSI reporting from a UE based on the signaling.

In an embodiment, the RRC signaling includes at least one of the following: one or multiple CSI resource configuration(s), one or multiple CSI report configuration(s), a first power offset set, a second power offset set, a third power offset set, a port set, or a TCI (Transmission Configuration Indicator) state set.

In an embodiment, the CSI resource comprises at least one of: one or more CSI-RS resource(s), one or more CSI-RS resource set(s), one or more CSI-RS resource setting(s).

In some embodiments, the power offsets in each CSI resource are configured independently. The CSI resource with different power offsets and/or different number of ports may be configured for CSI-RS measurement and CSI report. In an embodiment, the UE drives CSI feedback with different power offsets and/or different number of ports and/or different number of TCI states by the CSI resource update. In an embodiment, the UE drives CSI feedback with all configured CSI resources.

In an embodiment, the CSI report comprise at least one of: a multi-CSI report, or a single CSI report. When the multi-CSI report is configured, the number of ports and/or the power offsets associated with the multiple CSI report configurations may be different.

In an embodiment, the power offset as described herein corresponds to at least one of the power control offset values in the first power offset set, the power offset values in the second power offset set, the additional power offset in the third power offset set.

In an embodiment, each power offset set comprise one or more power offset(s). In some embodiments, the power offset set only includes one power offset. In some other embodiments, the power offset set is a power offset set which includes one or more power offset(s).

In an embodiment, the first power offset set includes one or more candidate power control offset(s), which is/are the assumed ratio of PDSCH EPRE (physical downlink shared channel energy per resource element) to NZP CSI-RS EPRE (non-zero power CSI-RS energy per resource element).

In an embodiment, the parameters powerControlOffset (which is the assumed ratio of PDSCH EPRE to NZP CSI-RS EPRE when UE derives CSI feedback and takes values in the range of [−8, 15] dB with 1 dB step size) and powerControlOffsetSS (which is the assumed ratio of NZP CSI-RS EPRE to SS/PBCH block EPRE) for which the UE may assume non-zero transmission power for CSI-RS resource are configured via the higher layer parameter NZP-CSI-RS-Resource, CSI-ResourceConfig and NZP-CSI-RS-ResourceSet for each CSI-RS resource configuration.

In an embodiment, the second power offset set includes one or more candidate power offset(s), which is/are the assumed ratio of NZP CSI-RS EPRE to SS/PBCH (synchronization signal/Physical Broadcast Channel) block EPRE.

In an embodiment, the third power offset set includes one or more candidate additional power offset(s), which is/are used to compensate for the power Control Offset (an assumed ratio of PDSCH EPRE to NZP CSI-RS EPRE, or an assumed ratio of NZP CSI-RS EPRE to SS/PBCH block EPRE).

In an embodiment, the third power offset set is the compensation of the powerControlOffset. The sum of the third power offset and powerControlOffset is the actual used assumed ratio of PDSCH EPRE to NZP CSI-RS EPRE when the UE derives the CSI feedback. When more than one third power offset are configured, the values of configured powerControlOffset and each third power offset in the third offset list are added respectively. For example, if the powerControlOffset is configured with a value −2 dB, the third power offset set is configured as a power offset list with values {−3, 0, 3, 6} dB, then for CQI calculation, the actual used assumed ratio of PDSCH EPRE to NZP CSI-RS EPRE when UE derives CSI feedback should be the configured powerControlOffset value plus the configured third power offset values in the third power offset list, and take values of {−5, −2, 1, 4} dB.

In an embodiment, the range of the value of the third power offset is [−X, X] dB with 1 dB step size. X may be 23.

In an embodiment, the UE does not expect the combination of the powerControlOffset and the third power offset to exceed the range of [−8, 15] dB with 1 dB step size. The sum of the value of configured powerControlOffset and the values in the third power offset set should be within the range of [−8, 15] dB.

In an embodiment, at least one of the first power offset set, the second power offset set, and the third power offset set are configured in at least one of the following: the NZP- CSI-RS-Resource, the NZP-CSI-RS-ResourceSet, or the CSI-ResourceConfig.

In an embodiment, the first power offset set, the second power offset set, and the third power offset set are configured in the NZP-CSI-RS-Resource. In another embodiment, the first power offset set and the second power offset set are configured in the NZP-CSI-RS-Resource. In another embodiment, the third power offset set is configured in the NZP-CSI-RS-Resource, and each CSI-RS resource contains a third power offset set. The candidate power offsets in the third power offset set may act on the current CSI-RS resource.

In an embodiment, the third power offset set is configured in the NZP-CSI-RS-ResourceSet, when more than one CSI-RS resources are configured in the CSI-RS resource set, and the candidate power offsets in the third power offset set may act on all the CSI-RS resources associated with the CSI-RS resource set. In another embodiment, the third power offset set is configured in the CSI-ResourceConfig, and the candidate power offsets in the third power offset set may act on all the CSI-RS resources associated with the CSI-ResourceConfig.

In some embodiments, the TCI state set includes one or multiple TCI states. In some examples, the TCI state is associated with the CSI-RS, PRS, or SRS. In some examples, the TCI state provides at least one of QCL (Quasi co-location) source, QCL type, or spatial information. In some embodiments, the TCI state can be “spatial information”.

In an embodiment, the MAC CE indicates the enabled/disabled state (activation/deactivation or available/unavailable) of one or more of the power offsets within at least one of the first power offset set, the second power offset set and the third power offset set, and/or the activation/deactivation (enabled/disabled) state of one or more CSI resources, and/or the enabled/disabled (activation/deactivation, or available/unavailable) of one or more TCI states within the TCI state set.

In an embodiment, the MAC CE may have at least one of following fields:

In an embodiment, a first field is to indicate the identity of the Serving Cell for which the MAC CE applies.

In an embodiment, a second field is to indicate BWP (bandwidth part) ID for which the MAC CE applies.

In an embodiment, a third field is to indicate the available/unavailable of the power offsets in the first power offset set.

In an embodiment, more than one power offset in the first power offset set can be indicated to be available.

In an embodiment, a fourth field is to indicate the available/unavailable of the power offsets in the second power offset set.

In an embodiment, more than one power offset in the second power offset set can be indicated to be available.

In an embodiment, a fifth field is to indicate the available/unavailable of the power offsets in the third power offset set.

In an embodiment, more than one power offset in the third power offset set can be indicated to be available.

In an embodiment, a sixth field is to identify the CSI resource configuration.

In an embodiment, the sixth field comprises at least one of the following:
one or more CSI-RS resource ID(s),
one or more CSI-RS resource set ID(s),
one or more CSI-ResourceConfig ID(s),

In an embodiment, a seventh field is to indicate the updated CSI resources.

In an embodiment, the seventh field indicates the activation and/or the deactivation of the CSI resources.

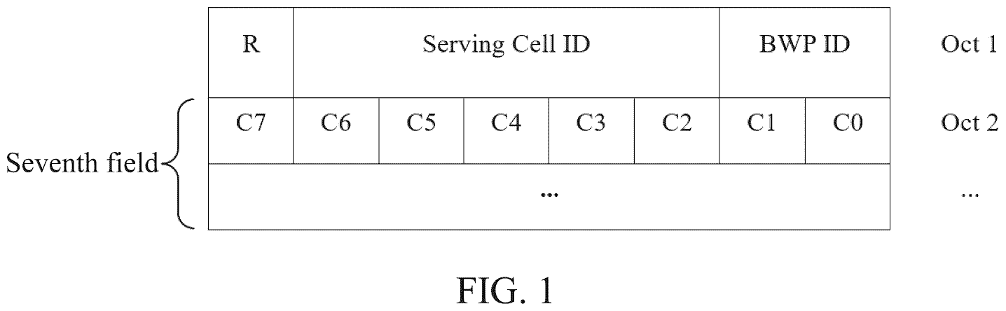

In some embodiments, the seventh field is a Ci field. The Ci field corresponds to an identity i (e.g., an integer). The identity comprises at least one of a CSI-RS resource ID, a CSI-RS resource set ID or a CSI-ResourceConfig ID. Each identity associated with a CSI resource. The Ci field is set to 1 to indicate that the corresponding CSI resource enabled/activated, and the Ci field set to 0 to indicate that the corresponding CSI resource disabled/deactivated. FIG. 1 shows an example of the signaling according to an embodiment of the present disclosure, in which “Oct” may denote “octal”.

In an embodiment, an eighth field is to indicate the available/unavailable of the TCI state in the TCI state set.

In an embodiment, a reversed field may be also included in the MAC CE and the bits in this field are set to 0.

In an embodiment, the MAC CE indicates the available/unavailable status of the power offset by indicating the available/unavailable status of the power offset values in the power offset set. In another embodiment, MAC CE indicates the available/unavailable status of the power offset by indicating the available/unavailable of the CSI resource associated with the power offset.

In an embodiment, the MAC CE is used for at least one of: the periodic CSI-RS, the Semi-persistent (SP) CSI-RS, or the aperiodic CSI-RS.

In an embodiment, the MAC CE is not used for aperiodic CSI-RS. The signaling may only be used for the SP CSI-RS resource and the periodic CSI-RS.

In an embodiment, the MAC CE is not used for aperiodic CSI-RS and SP CSI-RS. The signaling may only be used for the periodic CSI-RS.

In some other examples, the MAC CE may be used for at least one of: the periodic SRS, the Semi-persistent (SP) SRS (sounding reference signal), or the aperiodic SRS.

In some other examples, the MAC CE may be used for the PRS (positioning reference signal).

In an embodiment, the bit(s) in any of the third field, the fourth field and the fifth field is/are in a form of a bitmap. Each bit in the field may correspond to a power offset or a group of the power offset. A bit may be set to 1 to indicate that the corresponding power offset is enabled/activated, and a bit may be set to 0 to indicate that the corresponding power offset is disabled/deactivated. In an embodiment, the third field has a size of M bits, each bit corresponds to one power offset in the first power offset set, and the i-th bit (Ti-1) in the third field is to indicate whether the i-th configured power offset in the first power offset set is enabled/activated or not. When the number of the power offset is less than i, the MAC entity may ignore the i-th bit.

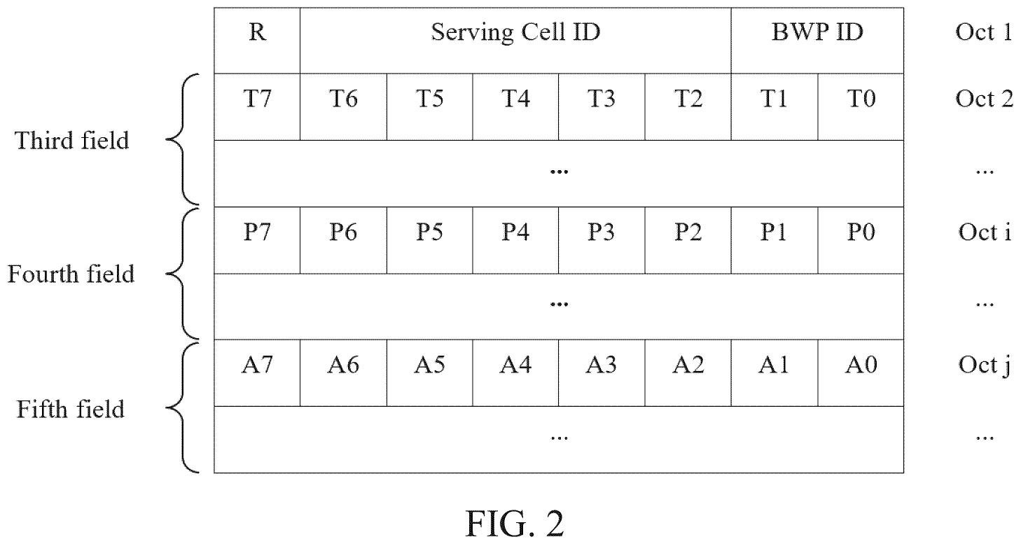

FIG. 2 shows an example of the signaling according to an embodiment of the present disclosure, in which “Oct” may denote “octal”.

In some embodiments, more than one CSI-RS resource ID and power offset indication corresponding to the CSI-RS resource with IDO are indicated in the MAC CE. The CSI-RS resource ID comprises at least one of a CSI-RS resource ID, a CSI-RS resource set ID or a CSI-ResourceConfig ID. The power offset indication comprises at least one of an indication indicating the first power offset set, an indication indicating the second power offset set, or an indication indicating the third power offset set.

In some embodiments, one or multiple power offsets are indicated by MAC CE. In some embodiments, the i-th power offset corresponds to the i-th CSI-RS resource, where i is a non-negative integer. In some embodiment, the i-th CSI-RS resource is determined by higher layer signaling. In some embodiments, the i-th CSI-RS resource is determined by the order of the CSI-RS resource indicated by the MAC CE.

In some embodiments, one or multiple TCI states are indicated by the MAC CE. In some embodiments, the i-th TCI state corresponds to the i-th resource, where i is a non-negative integer. In some embodiment, the i-th resource is determined by higher layer signaling. In some examples, the resource includes resource for the PDCCH, the CSI-RS, the PRS, the DM-RS, and/or the SRS. In some embodiments, the i-th resource is determined by the order of CSI-RS resource indicated by the MAC CE.

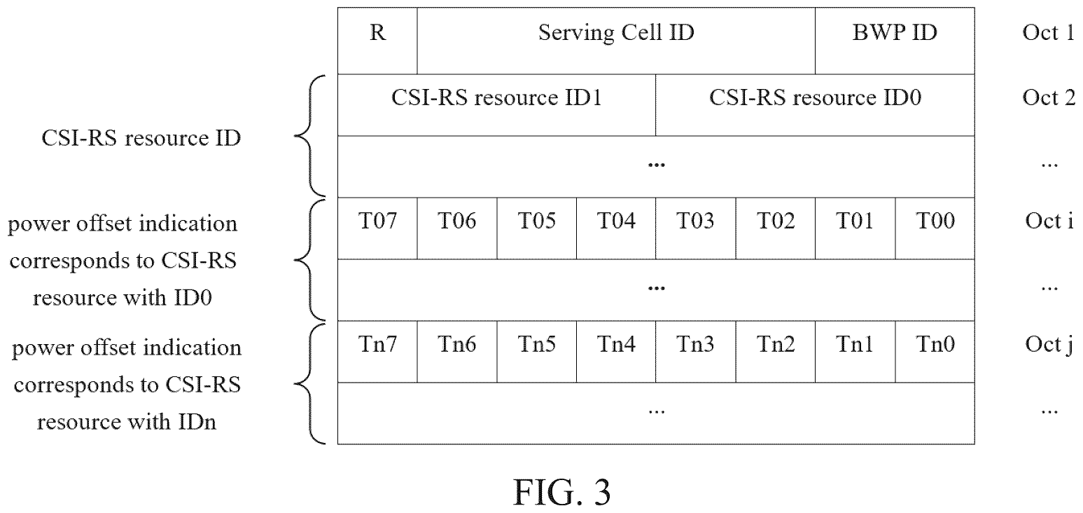

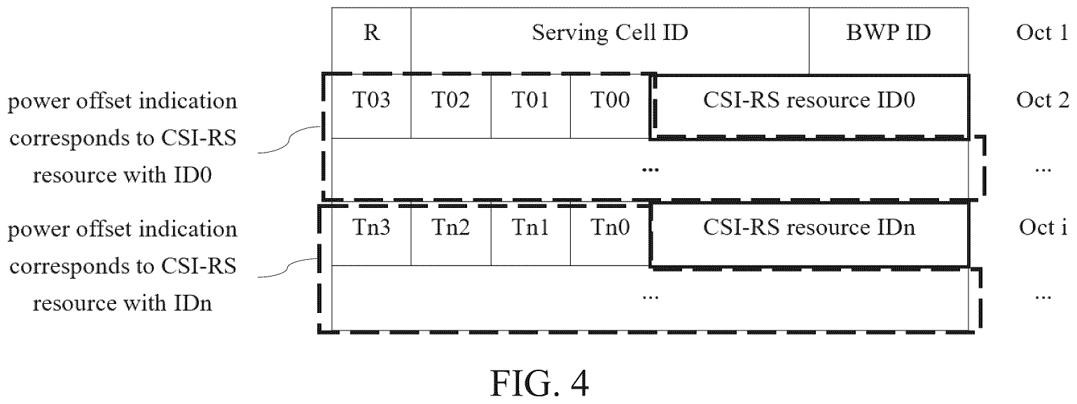

FIGS. 3 and 4 show examples of the signaling according to an embodiment of the present disclosure, in which “Oct” may denote “octal”. In some embodiments, the MAC CE includes a sixth field to indicate a CSI resource ID (as indicated by the bold frame), and the MAC CE indicates the available/unavailable of the power offset corresponding to the CSI resource with the indicated ID.

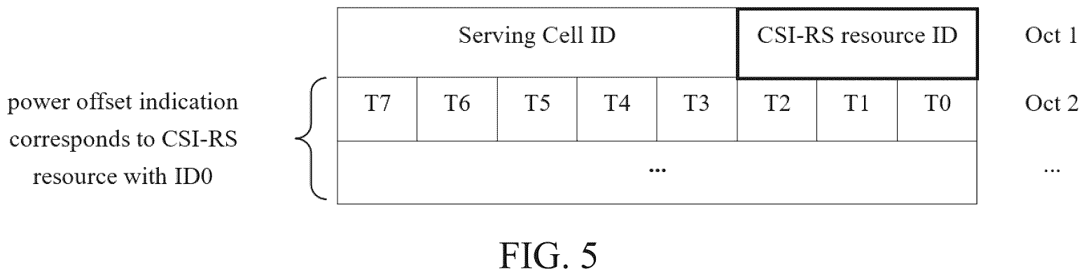

FIG. 5 shows an example of the signaling according to an embodiment of the present disclosure, in which “Oct” may denote “octal”.

In an embodiment, an indication of the MAC CE is effective under at least one of the following conditions, wherein the indication of the MAC CE being effective indicates at least one of: a CSI measurement being performed by the wireless communication terminal using one or more indicated power offsets, a CSI measurement being performed by the wireless communication terminal using an updated CSI resource, or a CSI measurement being performed by the wireless communication terminal using an updated CSI resource.

In an embodiment, the indication takes effect after a duration. In an embodiment, the duration can be a fixed value, e.g., 3 ms after the HARQ-ACK (hybrid automatic repeat request acknowledgement) of the MAC CE indication. In an embodiment, the duration is determined by at least one of the following: SCS, UE capability. In an embodiment, the duration is a*2n, where a is non-negative, and n is no less than 0.

In an embodiment, the indication takes effect from the next CSI-RS measurement occasion.

In an embodiment, the indication takes effect until a CSI report is triggered. The CSI report can be a semi-persistent CSI report or an aperiodic CSI report.

For example, when the MAC CE indicates the available/unavailable of the power offsets and/or the activation/deactivation of the CSI resource, the indication takes effect comprises the UE performs the CSI measurement using the indicated power offsets and/or the UE performs the CSI measurement using the updated CSI resource.

In an embodiment, when the MAC CE indicates the available/unavailable of the power offsets and/or the activation/deactivation of the CSI resource, the UE derives the CSI feedback with the indicated power offsets and/or updated CSI resource with at least one of the following conditions.

In an embodiment, the indication in the MAC CE takes effect.

In an embodiment, the old power offset values are applied until the new values take effect.

In an embodiment, the UE derives the CSI feedback with the old CSI resource until the updated CSI resource takes effect.

In an embodiment, the old CSI resource refers to the activated CSI resource before the MAC CE is transmitted.

In an embodiment, the CSI-RS measurement results with old CSI resource or old power offset values are dropped when the MAC CE is received.

In an embodiment, CSI feedback is derived from the next CSI reporting occasion.

In an embodiment, CSI feedback is derived after receiving a DCI which triggers a CSI reporting, wherein the CSI reporting is a semi-persistent CSI report or an aperiodic CSI report.

In an embodiment, the UE derives the CSI feedback with the new power offsets and/or updated CSI resources from the next CSI reporting occasion for a periodic CSI reporting.

In an embodiment, the UE derives the CSI feedback with the new power offsets and/or updated CSI resources from the next CSI reporting occasion for a semi-persistent CSI reporting.

In an embodiment, for a semi-persistent CSI reporting, when a semi-persistent CSI report is activated by a previously received DCI scrambled with SP-CSI-RNTI (Semi-Persistent CSI RNTI), the MAC CE does not take effect until a new semi-persistent CSI report is activated.

In an embodiment, the UE derives the CSI feedback with the new power offsets and/or updated CSI resources after receiving of the DCI triggering one or more new power offsets or one or more new CSI resources.

In an embodiment, when a semi-persistent CSI report is activated by a previously received DCI scrambled with SP-CSI-RNTI, the MAC CE takes effect from the next CSI reporting occasion of the current activated semi-persistent CSI report.

In an embodiment, the UE derives the CSI feedback with the new power offsets and/or updated CSI resources when receiving the DCI which triggers an aperiodic CSI reporting.

In an embodiment, if the MAC entity receives a MAC CE to indicate the activation/deactivation of the power offsets and/or the activation/deactivation of the CSI resource, the MAC entity may indicate to lower layers the information.

In an embodiment, the DCI is at least one of: a DCI format 0_1 or DCI format 0_2 with CRC (cyclic redundancy check) scrambled by C-RNTI (cell radio network temporary identifier), and/or CS-RNTI (configured scheduling RNTI), and/or MCS-C-RNTI (modulation and coding scheme C-RNTI), and/or SP-CSI-RNTI, and/or a DCI format 0_1 or DCI format 0_2 with CRC scrambled by a new RNTI (e.g., a NES-RNTI used for network energy saving enhancement), and/or a new DCI format (e.g., a group common DCI used for notifying the assumed power offsets related to the DL transmission and/or used for updating the CSI resource used for CSI measurement and/or CSI report), a DCI format 2-1, a DCI format 2-2, a DCI format 2-6, or a DCI format 2-7.

In an embodiment, the DCI comprises at least one of the following:

A first field used as a flag to indicate whether the fields in the DCI are reinterpreted.

In an embodiment, if the first field includes one or more bits, the bits are set to 0 to indicate the meaning of the target field is not changed, and the bits are set to 1 to indicate the target field is reinterpreted, e.g., the target field is used to indicate the power offset related information or CSI resource. Alternatively, the bit is set to 1 to indicate the meaning of the target field is not changed, and the bit is set to 0 to indicate the target field is reinterpreted.

In an embodiment, the first field includes one bit to indicate whether a new field relative to exists in the DCI. In an embodiment, the bit is set to 0 to indicate no new field is configured, and the bit is set to 1 to indicate there is a new field configured. Wherein the new field is used to indicate the power offset or the CSI resource related information.

In an embodiment, the DCI is a DCI format 0_1 with CRC scrambled by SP-CSI-RNTI, when the first field is set to 0, the CSI request field is used to activate one of the trigger states. When the first field is set to 1, the CSI request field is represented to indicate the selected power offset.

In some examples, the first field includes at least one of frequency domain resource assignment (FDRA) field, the time domain resource assignment (TDRA) field, a Modulation and coding scheme field, a Redundancy version field, a HARQ process number field, or a downlink assignment index field.

In some examples, the first field includes the frequency domain resource assignment (FDRA) field. For example, if all bits of the frequency domain resource assignment are set to 0, it means that at least one of the other fields in the DCI are used for the power offsets and/or the CSI resources and/or the ports indication. For another example, if all bits of the frequency domain resource assignment are set to 1, it means that at least one of the other fields in the DCI are used for the power offsets and/or the CSI resources and/or the ports indication.

In some other examples, the first field includes the time domain resource assignment (TDRA) field. For example, if all bits of the TDRA are set to 0, it means that at least one of the other fields in the DCI are used for the power offsets and/or the CSI resources and/or the ports indication. For another example, if all bits of the TDRA are set to 1, it means that at least one of the other fields in the DCI are used for the power offsets and/or the CSI resources and/or the ports indication.

In some other examples, the first field is a new field added in the DCI.

In an embodiment, the first field includes one bit to indicate the type of the power offset to be used. The bit is set to 0 to indicate the legacy power offset, and the bit is set to 1 to indicate the enhanced power offset. When the enhanced power offset is indicated, the UE derives CSI feedback and takes values of the enhanced power offset. The CQI calculation is based on the enhanced power offset.

In an embodiment, the DCI comprises a second field to indicate the selected power offsets.

In some examples, the second field includes at least one of a Modulation and coding scheme field, a Redundancy version field, a HARQ process number field, a downlink assignment index field, a TPC (transmission power control) command field, an antenna port(s) field, or a Transmission configuration indication field.

In an embodiment, the power offset corresponds to at least one of the power control offset in the first power offset set, the power offset in the second power offset set, the additional power offset in the third power offset set.

In an embodiment, the DCI indicates the selected power offset by indicating the available/unavailable state of the power offset values in the power offset set. In an embodiment, the DCI indicates the selected power offset by indicating the CSI resource corresponding to the power offset.

In an embodiment, the second field is in a form of a codepoint.

In an embodiment, when all the bits in second field are set to 0, the default power offset or the legacy power offset is used. For the non-zero codepoint value, each codepoint is mapped to one target power offset or one target power offset group.

In an embodiment, each codepoint is mapped to one target power offset or a target power offset group, wherein the codepoint i corresponds to the (i+1)-th target power offset or the (i+1)-th target power offset group.

In an embodiment, the target power offset is the configured power offset or the power offset activated/enabled state by the MAC CE.

In an embodiment, the second field is in a form of a bitmap.

In an embodiment, each bit of the second field corresponds to one target power offset or one target power offset group.

In an embodiment, the target power offset is the configured power offset or the power offset activated/enabled state by the MAC CE.

In an embodiment, the length of the second field is determined by a higher layer parameter, or set to a fixed number (e.g., 5 bits).

In an embodiment, a third field indicates one or more updated CSI resources.

In an embodiment, the third field is in a form of a codepoint.

In an embodiment, each codepoint of the third field is associated with one CSI resource ID or one CSI resource group ID.

In an embodiment, the third field is in a form of a bitmap.

In an embodiment, each bit of the third field associated with one CSI resource ID or one CSI resource group ID.

In an embodiment, the length of the third field is determined by a higher layer parameter, or set to a fixed number (e.g., 5 bits).

In an embodiment, a fourth field is to indicate the cell DTX/DRX or the UE CDRX configuration related information.

In an embodiment, a fifth field is to indicate the number of ports used for CSI measurement and/or report.

In an embodiment, a sixth field indicates an identity, wherein the identity comprises at least one of the following:
a BWP ID,
one or more CSI-RS resource ID(s),
one or more CSI-RS resource set ID(s), or
one or more CSI-ResourceConfig ID(s).

In an embodiment, a seventh field indicates the available/unavailable of the TCI state in the TCI state set.

In some embodiments, one or multiple TCI states are indicated by the DCI. In some embodiments, the i-th TCI state corresponds to the i-th resource, where i is a non-negative integer. In some embodiment, the i-th resource is determined by higher layer signaling. In some examples, the resource includes resource for the PDCCH, CSI-RS, PRS, DM-RS, and/or SRS.

In an embodiment, at least one of the first field to the sixth field is reinterpreted. In an embodiment, any of the first field to the sixth field is a new field.

For example, the DCI is a DCI format 0_1 with the CRC scrambled by the SP-CSI-RNTI, the CSI request field is represented to indicate the selected power offset.

For another example, the DCI is a DCI format 2_6. The dormancy indication field is represented to indicate the selected power offset or the updated CSI resource.

In some examples, at least one of the first field to the sixth field are reinterpreted by the frequency domain resource assignment (FDRA) field and/or the time domain resource assignment (TDRA) field. For example, the FDRA field and/or the TDRA field are used for power offsets and/or the CSI resources and/or the ports indication.

For another examples, at least one of the following fields concatenated in the order below are reinterpreted: FDRA, TDRA, Modulation and coding scheme (MCS), new data indicator, redundancy version.

In an embodiment, the DCI is configured with N blocks (wherein N≥1), and each block includes one or more field(s).

In an embodiment, the starting position of a block is determined by the higher layer parameter. In an embodiment, the starting position of a block can be calculated according to the length of the field within the block.

In an embodiment, one block is associated with at least one of: a UE ID, an index (e.g., UE group index), a CSI resource ID, or a BWP ID.

In an embodiment, each block includes one or more indication(s), the indication(s) is/are used to indicate network energy saving related information. In an embodiment, the network energy saving related information comprises at least one of the available/unavailable state of the power offset, the available/unavailable state of the CSI resource, the power offset index, the CSI resource ID, the number of ports used for CSI measurement and/or report, the cell DTX/DRX configuration or the C-DRX configuration.

In an embodiment, each block includes one or more independent field(s), wherein each field is associated with one indication. In an embodiment, each block includes a second field, or each block includes a second field and a fifth field.

In an embodiment, the indications in each block are jointly indicated. In an embodiment, the indications in the block used for indicating the selected power offsets and the number of ports for CSI measurement and/or CSI report are jointly encoded. Each codepoint of the indication may be associated with a combination of a power offset value and a number of ports used for CSI measurement and/or CSI report.

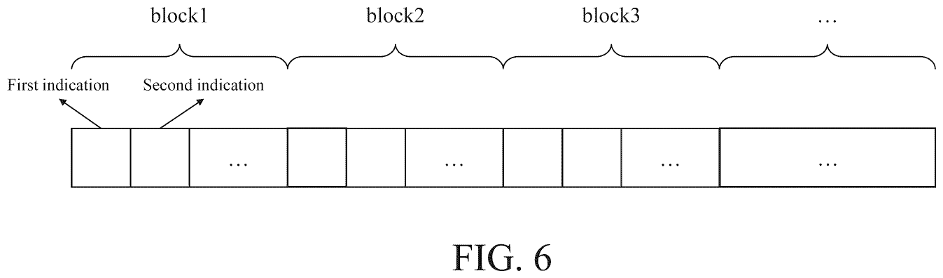

FIG. 6 shows an example of the signaling according to an embodiment of the present disclosure, in which “Oct” may denote “octal”.

In an embodiment, after receiving the DCI, the indication in the DCI takes effect with at least one of the following conditions.

In an embodiment, the indication in the DCI takes effect after a duration, wherein the duration can be a fixed value, e.g., next slot. In an embodiment, the duration is determined by at least one of the following: SCS, or UE capability. In an embodiment, the duration is a*2n, where a is non-negative, and n is no less than 0.

In an embodiment, the indication in the DCI takes effect from the next CSI-RS measurement occasion.

In an embodiment, the indication in the DCI takes effect until a CSI report is triggered. The CSI report can be a semi-persistent CSI report or an aperiodic CSI report.

In an embodiment, after receiving the DCI, the UE derives the CSI feedback according to the indication in the DCI with at least one of the following conditions.

In an embodiment, the indication in the DCI takes effect.

In an embodiment, the indication indicates a set of power offsets, the old power offset values are applied until the new values take effect.

In an embodiment, the indication indicates a new CSI resource, and the UE derives the CSI feedback with the old CSI resource until the updated CSI resource takes effect, wherein the old CSI resource refers to the activated CSI resource before the DCI is transmitted.

In an embodiment, the CSI-RS measurement results with the old CSI resource and/or old power offset values are dropped.

In an embodiment, the UE derives the CSI feedback from the next CSI reporting occasion.

In an embodiment, receiving a DCI triggers a CSI reporting, where the CSI reporting is a semi-persistent CSI report or an aperiodic CSI report.

In an embodiment, the UE derives the CSI feedback with the indicated power offset and/or the updated CSI resource from the next CSI reporting occasion for a periodic CSI reporting or a semi-persistent CSI reporting.

In an embodiment, the UE derives the CSI feedback with the indicated power offset and/or the updated CSI resource after receiving a DCI which triggers a semi-persistent CSI reporting.

In an embodiment, when a semi-persistent CSI report is activated by a previously received DCI scrambled with SP-CSI-RNTI, the indicated power offset and/or the updated CSI resource does not take effect until one semi-persistent CSI report with a new CSI-ReportConfigId is activated.

In an embodiment, when a semi-persistent CSI report is activated by a previously received DCI scrambled with SP-CSI-RNTI, the indicated power offset and/or the updated CSI resource takes effect from the next CSI reporting occasion of the current activated semi-persistent CSI report.

In an embodiment, the UE derives the CSI feedback with the indicated power offset and/or the updated CSI resource when receiving the DCI triggers an aperiodic CSI reporting.

### The Indicated Power Offset

In some embodiments, the UE does not expect more than one power offset to be indicated for CQI calculation.

In an embodiment, when more than one power offset is indicated/activated, each indicated/activated power offset is used for CQI calculation.

In an embodiment, all the CQI corresponding to the different power offset are reported when the UE derives CSI feedback.

In an embodiment, only the pre-determined CQI is selected to report when the UE derives CSI feedback.

In an embodiment, the pre-determined CQI includes at least one of the following: the CQI with a minimum CQI index, or the CQI with a maximum CQI index.

### The Restriction of the Signaling

In an embodiment, the signaling takes effect only when the CSI-RS is configured for channel measurement and/or interference measurement.

In an embodiment, the signaling takes effect only when a CSI report quantity can be configured as: ‘cri-RI-PMI-COI’, ‘cri-RI-il-COI’, ‘cri-RI-CQI’, or ‘cri-RI-LI-PMI-CQI’.

In an embodiment, UE is not expected to be affected by the signaling except the CSI-RS for CSI acquisition.

In an embodiment, the signaling is not applied to at least one of the following:
the CSI-RS for the tracking;
the CSI-RS for the L1-SINR computation;
the CSI-RS for the mobility; or
the CSI-RS for the L1-RSRP computation.

In an embodiment, the signaling is used for at least one of: the periodic CSI-RS, the Semi-persistent (SP) CSI-RS, or the aperiodic CSI-RS.

In an embodiment, the signaling is not used for the aperiodic CSI-RS. The signaling is only used for the SP CSI-RS resource and the periodic CSI-RS.

In an embodiment, the signaling is not used for the aperiodic CSI-RS and the SP CSI-RS. The signaling is only used for the periodic CSI-RS.

In an embodiment, the signaling is used for the aperiodic CSI-RS, the SP CSI-RS and the periodic CSI-RS.

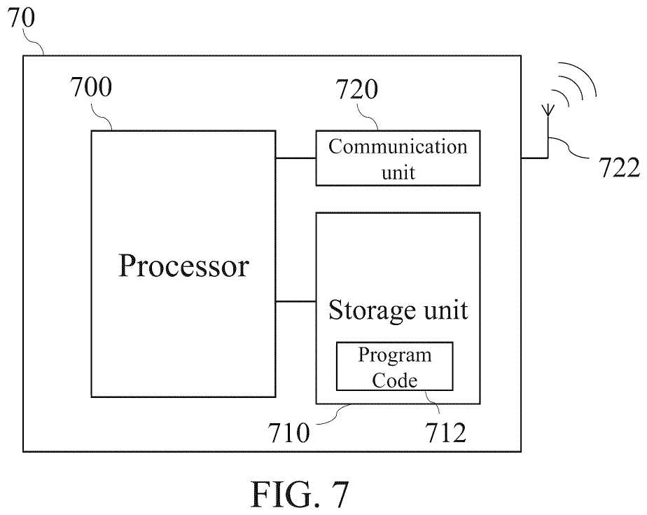

FIG. 7 relates to a schematic diagram of a wireless terminal 70 according to an embodiment of the present disclosure. The wireless terminal 70 may be a user equipment (UE), a mobile phone, a laptop, a tablet computer, an electronic book or a portable computer system and is not limited herein. The wireless terminal 70 may include a processor 700 such as a microprocessor or Application Specific Integrated Circuit (ASIC), a storage unit 710 and a communication unit 720. The storage unit 710 may be any data storage device that stores a program code 712, which is accessed and executed by the processor 700. Embodiments of the storage unit 712 include but are not limited to a subscriber identity module (SIM), read-only memory (ROM), flash memory, random-access memory (RAM), hard-disk, and optical data storage device. The communication unit 720 may a transceiver and is used to transmit and receive signals (e.g., messages or packets) according to processing results of the processor 700. In an embodiment, the communication unit 720 transmits and receives the signals via at least one antenna 722 shown in FIG. 7.

In an embodiment, the storage unit 710 and the program code 712 may be omitted and the processor 700 may include a storage unit with stored program code.

The processor 700 may implement any one of the steps in exemplified embodiments on the wireless terminal 70, e.g., by executing the program code 712.

The communication unit 720 may be a transceiver. The communication unit 720 may as an alternative or in addition be combining a transmitting unit and a receiving unit configured to transmit and to receive, respectively, signals to and from a wireless network node (e.g., a base station).

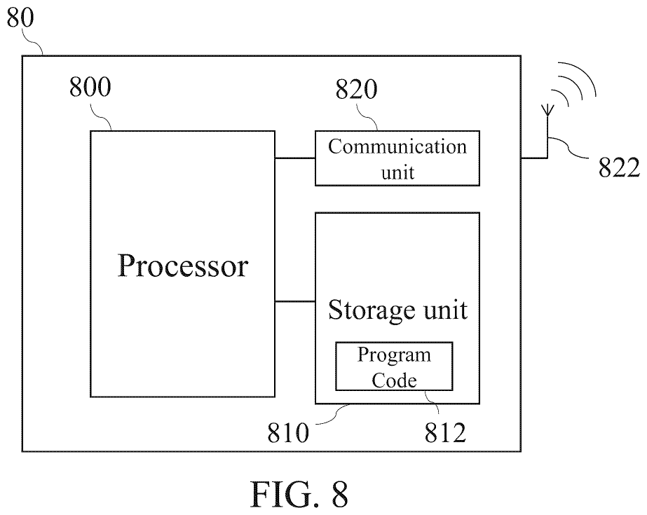

FIG. 8 relates to a schematic diagram of a wireless network node 80 according to an embodiment of the present disclosure. The wireless network node 80 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 80 may comprise (perform) at least one network function such as an access and mobility management function (AMF), a session management function (SMF), a user place function (UPF), a policy control function (PCF), an application function (AF), etc. The wireless network node 80 may include a processor 800 such as a microprocessor or ASIC, a storage unit 810 and a communication unit 820. The storage unit 810 may be any data storage device that stores a program code 812, which is accessed and executed by the processor 800. Examples of the storage unit 812 include but are not limited to a SIM, ROM, flash memory, RAM, hard-disk, and optical data storage device. The communication unit 820 may be a transceiver and is used to transmit and receive signals (e.g., messages or packets) according to processing results of the processor 800. In an example, the communication unit 820 transmits and receives the signals via at least one antenna 822 shown in FIG. 8.

In an embodiment, the storage unit 810 and the program code 812 may be omitted. The processor 800 may include a storage unit with stored program code.

The processor 800 may implement any steps described in exemplified embodiments on the wireless network node 80, e.g., via executing the program code 812.

The communication unit 820 may be a transceiver. The communication unit 820 may as an alternative or in addition be combining a transmitting unit and a receiving unit configured to transmit and to receive, respectively, signals to and from a wireless terminal (e.g., a user equipment or another wireless network node).

A wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 70 described above, but is not limited thereto.

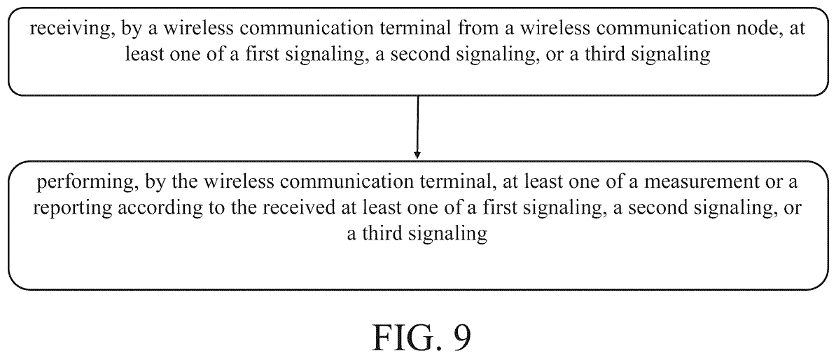

Referring to FIG. 9, in an embodiment, the wireless communication method includes: receiving, by a wireless communication terminal from a wireless communication node, at least one of a first signaling, a second signaling, or a third signaling; and performing, by the wireless communication terminal, at least one of a measurement or a reporting according to the received at least one of a first signaling, a second signaling, or a third signaling.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a gNB). In an embodiment, the wireless communication node may be implemented by using the wireless communication node 80 described above, but is not limited thereto.

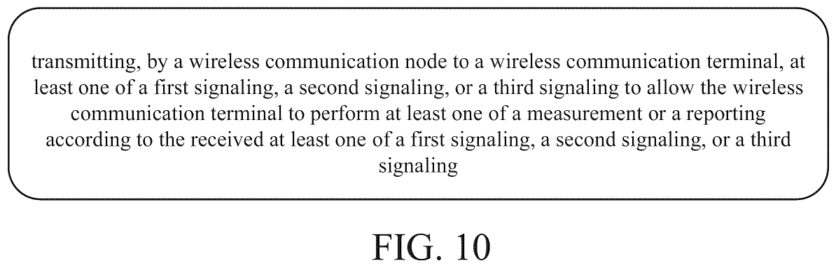

Referring to FIG. 10, in an embodiment, the wireless communication method includes transmitting, by a wireless communication node to a wireless communication terminal, at least one of a first signaling, a second signaling, or a third signaling to allow the wireless communication terminal to perform at least one of a measurement or a reporting according to the received at least one of a first signaling, a second signaling, or a third signaling.

In some embodiments, the wireless communication method further includes receiving, by the wireless communication node from the wireless communication terminal, the reporting based on the at least one of the first signaling, the second signaling, or the third signaling.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method comprising:
receiving, by a wireless communication terminal from a wireless communication node, at least one of a first signaling, a second signaling, or a third signaling; and
performing, by the wireless communication terminal, at least one of a measurement or a reporting according to the received at least one of a first signaling, a second signaling, or a third signaling.

2. The wireless communication method of claim 1, wherein the measurement comprises at least one of a channel state information (CSI) measurement, or a beam measurement; and the reporting comprises at least one of a CSI reporting or beam reporting.

3. The wireless communication method of claim 1, wherein the first signaling comprises Radio Resource Control (RRC) signaling, and the RRC signaling comprises at least one of:
one or more CSI resource configurations for one or more CSI resources, one or more CSI report configurations, a first power offset set, a third power offset set, or a port set;
wherein the first power offset set comprises one or more candidate power control offsets, wherein the candidate power control offset is the assumed ratio of a physical downlink shared channel (PDSCH) Energy Per Resource Element (EPRE), to a non-zero-power (NZP) CSI-RS EPRE;
wherein the third power offset set comprises one or more candidate power control offsets, wherein the candidate power control offset is a compensating power offset for compensating for an assumed ratio of a PDSCH EPRE, to an NZP CSI-RS EPRE;
wherein the first power offset set is configured in: an NZP-CSI-RS-Resource information element.

4. The wireless communication method of claim 3, wherein the CSI resources comprise at least one of: one or more channel state information reference signal (CSI-RS) resources, one or more CSI-RS resource sets, or one or more CSI-RS resource settings.

5. The wireless communication method of claim 3, wherein a combination of the first offset and the third power offset does not exceed a range of [−8, 15] dB with 1 dB step size.

6. The wireless communication method of claim 1, wherein the second signaling comprises a Medium Access Control Control Element (MAC CE), and the MAC CE indicates at least one of: an activation or deactivation of one or more candidate power control offsets within at least one of the first power offset set, or the third power offset set, or an activation or deactivation of one or more CSI resources.

7. The wireless communication method of claim 6, wherein the MAC CE comprises at least one of:
a first field to indicate an identity of a serving cell for which the MAC CE applies;
a second field to indicate a bandwidth part (BWP) identifier for which the MAC CE applies;
a third field to indicate the activation or deactivation of candidate power control offsets in the first power offset set;
a fifth field to indicate the activation or deactivation of candidate power control offsets in the third power offset set; or
a sixth field to identify one or more CSI resources configuration, and the CSI resource configuration comprising at least one of:
one or more CSI-RS resource identifier;
one or more CSI-RS resource set identifier; or
one or more CSI-ResourceConfig identifier.

8. The wireless communication method of claim 1, wherein the third signaling comprises DCI, and the DCI is at least one of: a DCI format 0_1, a DCI format 0_2 with a cyclic redundancy check (CRC) scrambled by a Cell Radio Network Temporary Identifier (C-RNTI), a Configured Scheduling Radio Network Temporary Identifier (CS-RNTI), a Modulation and Coding Scheme Cell Radio Network Temporary Identifier (MCS-C-RNTI), a Semi-Persistent CSI RNTI (SP-CSI-RNTI), or a network energy saving RNTI (NES-RNTI), a DCI format 2-6, a DCI format 2-7, a DCI format 2-1, a DCI format 2-2, or a group common DCI.

9. The wireless communication method of claim 8, wherein the DCI comprises one or more fields comprising at least one of:
a first field comprising at least one of a flag indicating whether the one or more fields in the DCI are reinterpreted or an indication indicating a type of a power offset to be used;
a second field to indicate selected power offsets;
a third field to indicate one or more updated CSI resources;
a fourth field to indicate a cell discontinuous transmission and/or discontinuous reception (DTX/DRX), or user equipment (UE) connected mode discontinuous reception (CDRX) configuration related information;
a fifth field to indicate a number of ports used for at least one of a CSI measurement or a CSI report;
a sixth field to indicate at least one of:
a BWP identifier;
one or more CSI-RS resource identifiers;
one or more CSI-RS resource set identifiers;
one or more CSI-ResourceConfig identifiers;
or, a seventh field to indicate the activation or deactivation of the TCI states in the TCI state set.

10. The wireless communication method of claim 8, wherein the wireless communication terminal derives CSI feedback according to an indication of the DCI under least one of the following conditions:
an indication of the DCI is effective;
the wireless communication terminal derives the CSI feedback from a next CSI reporting occasion; or
the wireless communication terminal derives the CSI feedback after receiving information triggering a CSI reporting.

11. The wireless communication method of claim 1, wherein an indication of the first signaling is not applied on at least one of:
a CSI-RS for a tracking;
a CSI-RS for a layer 1 signal-to-noise and interference ratio (L1-SINR) computation;
a CSI-RS for a mobility; or
a CSI-RS for a layer 1 reference signal received power (L1-RSRP) computation.

12. A wireless communication method comprising:
transmitting, by a wireless communication node to a wireless communication terminal, at least one of a first signaling, a second signaling, or a third signaling to allow the wireless communication terminal to perform at least one of a measurement or a reporting according to the received at least one of a first signaling, a second signaling, or a third signaling, and
receiving, by the wireless communication node from the wireless communication terminal, a reporting based on at least one of the first signaling, the second signaling, or the third signaling.

13. The wireless communication method of claim 12, wherein the measurement comprises at least one of a channel state information (CSI) measurement, or a beam measurement; and
the reporting comprises at least one of a CSI reporting or beam reporting.

14. The wireless communication method of claim 12, wherein the first signaling comprises Radio Resource Control (RRC) signaling, and the RRC signaling comprises at least one of: one or more CSI resource configurations for one or more CSI resources, one or more CSI report configurations, a first power offset set, a third power offset set, or a port set.

15. The wireless communication method of claim 14, wherein the CSI resources comprise at least one of: one or more channel state information reference signal (CSI-RS) resources, one or more CSI-RS resource sets, or one or more CSI-RS resource settings;
wherein the first power offset set comprises one or more candidate power control offsets, wherein the candidate power control offset is the assumed ratio of a physical downlink shared channel (PDSCH) Energy Per Resource Element (EPRE) to a non-zero-power (NZP) CSI-RS EPRE.

16. The wireless communication method of claim 14, wherein the third power offset set comprises one or more candidate power control offsets, wherein the candidate power control offset is a compensating power offset for compensating for an assumed ratio of a PDSCH EPRE, to an NZP CSI-RS EPRE, or an assumed ratio of an NZP CSI-RS EPRE to a SS/PBCH block EPRE;
wherein the first power offset set is configured in an NZP-CSI-RS-Resource information element.

17. The wireless communication method of claim 14, wherein the combination of the first offset and the third power offset not exceed the range of [−8, 15] dB with 1 dB step size.

18. The wireless communication method of claim 12, wherein an indication of the first signaling is not applied on at least one of:
a CSI-RS for a tracking;
a CSI-RS for a layer 1 signal-to-noise and interference ratio (L1-SINR) computation;
a CSI-RS for a mobility; or
a CSI-RS for a layer 1 reference signal received power (L1-RSRP) computation.

19. A wireless communication terminal, comprising:
a communication unit; and
at least one processor configured to: receive, from a wireless communication node, at least one of a first signaling, a second signaling, or a third signaling; and perform at least one of a measurement or a reporting according to the received at least one of a first signaling, a second signaling, or a third signaling.

20. A wireless communication node, comprising:
a communication unit; and
at least one processor configured to: transmit, to a wireless communication terminal, at least one of a first signaling, a second signaling, or a third signaling to allow the wireless communication terminal to perform at least one of a measurement or a reporting according to the received at least one of the first signaling, the second signaling, or the third signaling.
